(19) United States
(12) Patent Application Publication
(10) Pub. No.: US 2014/0210963 A1
(43) Pub. Date: Jul. 31, 2014

(54) PARALLAX ADJUSTMENT APPARATUS AND METHOD OF CONTROLLING OPERATION OF SAME

(71) Applicant: FUJIFILM CORPORATION, Tokyo (JP)

(72) Inventors: Koichi TANAKA, Saitama-shi (JP); Koichi YAHAGI, Saitama-shi (JP)

(73) Assignee: FUJIFILM CORPORATION, Tokyo (JP)

(21) Appl. No.: 14/229,092

(22) Filed: Mar. 28, 2014

Related U.S. Application Data
(63) Continuation of application No. PCT/JP2012/071055, filed on Aug. 21, 2012.

(30) Foreign Application Priority Data
Sep. 29, 2011 (JP) 2011-214058

(51) Int. Cl. H04N 13/04

(52) U.S. Cl. CPC H04N 13/0409
USPC 348/54

(57) ABSTRACT

A parallax adjustment is facilitated. A stereoscopic image is displayed and the parallax between a left-viewpoint image and a right-viewpoint image, which form the stereoscopic image, is calculated. If the parallax of the stereoscopic image exceeds a prescribed allowable amount of parallax, a determination to reduce the size of the stereoscopic image is made. A parallax adjustment is carried out based upon a stereoscopic image, which has been reduced in size. Since parallax is adjusted using the stereoscopic image that has a parallax that falls within the allowable amount of parallax, parallax is easy to adjust.

### TECHNICAL FIELD

This invention relates to a parallax adjustment apparatus and to a method of controlling the operation of this apparatus.

### BACKGROUND ART

The prior art includes an apparatus for displaying, as a 3D image, a pair of left and right images having horizontal parallax acquired by so-called stereoscopic camera photography. Electrical appliances for home use such as televisions, smart phones and digital cameras that now come equipped with displays having a 3D display function have recently appeared.

Since individual differences affect 3D depth and pop-up perception, 3D display devices are often provided with a user-operated parallax (stereoscopic effect) adjustment mechanism. In general, one adjusts parallax by moving left and right images horizontally while observing a 3D image.

Also available are a stereoscopic image processing apparatus in which it is possible to adjust the mutual parallax of viewpoint images (Patent Document 1), a stereoscopic image display apparatus that is capable of adjusting the amount of parallax of stereoscopic vision (Patent Document 2), and an apparatus for adjusting a convergence point (Patent Document 3).

[Patent Document 1]: Japanese Patent Application Laid-Open No. 2005-130310

[Patent Document 2]: Japanese Patent Application Laid-Open No. 2004-289527

[Patent Document 3]: Japanese Patent Application Laid-Open No. 9-201472

Nevertheless, since a 3D image based upon left and right images having a large horizontal parallax applies an excessive amount of 3D pop-up and depth perception, it is difficult to adjust parallax while observing the image.

### DISCLOSURE OF THE INVENTION

An object of the present invention is to arrange it so that an appropriate parallax adjustment can be achieved.

A parallax adjustment apparatus according to the present invention is characterized by comprising: a parallax calculation device (parallax calculation means) for calculating, pixel by pixel, amount of parallax between a first image, which serves as a reference, and a second image, the first and second images having different viewpoints; a reduction ratio decision device (reduction ratio decision means) for deciding a reduction ratio of the first and second images based upon the amount of parallax calculated by the parallax calculation device and a prescribed allowable amount of parallax (where the allowable amount of parallax is that which affords a parallax-amount criterion that makes appropriate stereoscopic vision possible, and which depends upon the size and stereoscopic display scheme of the display device); a reduction device (reduction means) for reducing the first and second images at the reduction ratio decided by the reduction ratio decision device; a stereoscopic image display control device (stereoscopic image display control means) for controlling a display unit in such a manner that a stereoscopic image, which comprises the first and second images reduced by the reduction device, is displayed on a display screen; a first parallax adjustment device (first parallax adjustment means) for accepting a parallax-amount adjustment command and adjusting the amount of parallax between the first and second images, which have been reduced by the reduction device, in accordance with an amount of parallax commanded; and a second parallax adjustment device for making the amount of parallax, which existed prior to reduction by the reduction device, between the first and second images of different viewpoints, an amount of parallax that will exist when the first and second images, which have had their amount of parallax adjusted by the parallax adjustment device and have been reduced, are enlarged so as to take on the size that existed prior to the reduction by the reduction device.

The present invention also provides an operation control method suited to the above-described parallax adjustment apparatus. The method comprises: a parallax calculation device calculating, pixel by pixel, amount of parallax between a first image, which serves as a reference, and a second image, the first and second images having different viewpoints; a reduction ratio decision device deciding a reduction ratio of the first and second images based upon the amount of parallax calculated by the parallax calculation device and a prescribed allowable amount of parallax; a reduction device reducing the first and second images at the reduction ratio decided by the reduction ratio decision device; a stereoscopic image display control device controlling a display unit in such a manner that a stereoscopic image, which comprises the first and second images reduced by the reduction device, is displayed on a display screen; a first parallax adjustment device accepting a parallax adjustment command and adjusting the amount of parallax between the first and second images, which have been reduced by the reduction device, in accordance with an amount of parallax commanded; and a second parallax adjustment device making the amount of parallax, which existed prior to reduction by the reduction device, between the first and second images of different viewpoints, an amount of parallax that will exist when the first and second images, which have had their amount of parallax adjusted by the parallax adjustment device and have been reduced, are enlarged so as to take on the size that existed prior to the reduction by the reduction device.

In accordance with the present invention, a first image of first and second images having different viewpoints is adopted as a reference, the amount of parallax between the first and second images is calculated pixel by pixel, and a reduction ratio of the first and second images is decided based upon the calculated amount of parallax (in such a manner that the amount of parallax becomes an allowable amount of parallax). The first and second images are reduced in size at the reduction ratio decided. The reduced first and second images are displayed on a display screen and the amount of parallax is adjusted while observing the first and second images being displayed on the display screen.

Large images have a large amount of parallax. As a consequence, stereoscopic vision is difficult to achieve and adjusting the amount of parallax also is difficult. In accordance with the present invention, the first and second images are reduced in size and the amount of parallax between the first and second images in the reduced state is adjusted. This makes it easier to adjust the amount of parallax.

Preferably, the apparatus further comprises a second parallax adjustment device (second parallax adjustment means) for making the amount of parallax, which existed prior to reduction by the reduction device, of each pixel of pixels between the first and second images of different viewpoints, an amount of parallax that will exist when the first and second images, which have had their amount of parallax adjusted by the parallax-amount adjustment device and have been reduced, are enlarged so as to take on the size that existed prior to the reduction by the reduction device.

The second parallax adjustment device adjusts the amount of parallax in such a manner that the amount of parallax between the first and second images will fall below the allowable amount of parallax.

The reduction ratio decision device decides the reduction ratio in such a manner that the amount of parallax of pixels equal to or greater than a prescribed number of pixels among pixels of the first image will be the allowable amount of parallax, by way of example.

In a case where the first image has been partitioned into blocks of a prescribed size, the parallax calculation device, by way of example, calculates, block by block, the amount of parallax between the first image, which serves as a reference, and the second image, and the reduction ratio decision device performs, by way of example, reduction in such a manner that a maximum amount of parallax among absolute values of amounts of parallax of blocks, which have an amount of parallax equal to or greater than the allowable amount of parallax and the number of which is equal to or greater than a threshold value, will be the allowable amount of parallax.

The apparatus may further comprise: a first contrast adjustment device (first contrast adjustment means) for lowering contrast of the first and second images that have been reduced by the reduction device; and a second contrast adjustment device (second contrast adjustment means) for restoring the contrast of the first and second images, the amount of parallax of which has been adjusted by the second parallax adjustment device, to the contrast that existed prior to the adjustment of contrast by the first contrast adjustment device.

The parallax calculation device calculates amount of parallax of a subject image which, of the first and second images, is the image situated most forward, by way of example.

The parallax calculation device may calculate, from the first and second images, an amount of parallax of a predetermined prescribed subject. In this case, the reduction ratio decision device would calculate the amount of parallax of the prescribed subject calculated by the parallax calculation device, by way of example.

It may be arranged so that enlargement processing by the enlarging device is executed in such a manner that the amount of parallax of the first and second images after enlargement by the enlarging device will be the same as the amount of parallax adjusted by the parallax adjustment device.

### BRIEF DESCRIPTION OF THE DRAWINGS

FIG. 1 is a block diagram illustrating the electrical configuration of an image viewer;

FIG. 2 is a flowchart illustrating the processing procedure of an image viewer;

FIG. 3 is a flowchart illustrating the processing procedure of an image viewer;

FIG. 4 illustrates one example of a left-viewpoint image and a right-viewpoint image;

FIG. 5 is an example of a stereoscopic image;

FIG. 6 is an example of a parallax histogram;

FIG. 7 is an example of a stereoscopic image;

FIG. 8 is an example of a parallax histogram;

FIG. 9 is an example of a stereoscopic image;

FIG. 10 is an example of a parallax histogram;

FIG. 11 is an example of a stereoscopic image;

FIG. 12 is an example of a parallax histogram;

FIG. 13 is a flowchart illustrating a processing procedure for determining image reduction;

FIG. 14 is a flowchart illustrating a processing procedure for determining image reduction;

FIG. 15 is an example of a parallax histogram;

FIG. 16 illustrates an enlargement of a portion of a parallax histogram;

FIG. 17 illustrates an enlargement of a portion of a parallax histogram;

FIG. 18 is a flowchart illustrating the processing procedure of an image viewer;

FIG. 19 is a flowchart illustrating the processing procedure of an image viewer;

FIG. 20 is an example of a reduced stereoscopic image; and

FIG. 21 is an example of a reduced stereoscopic image.

### BEST MODE FOR CARRYING OUT THE INVENTION

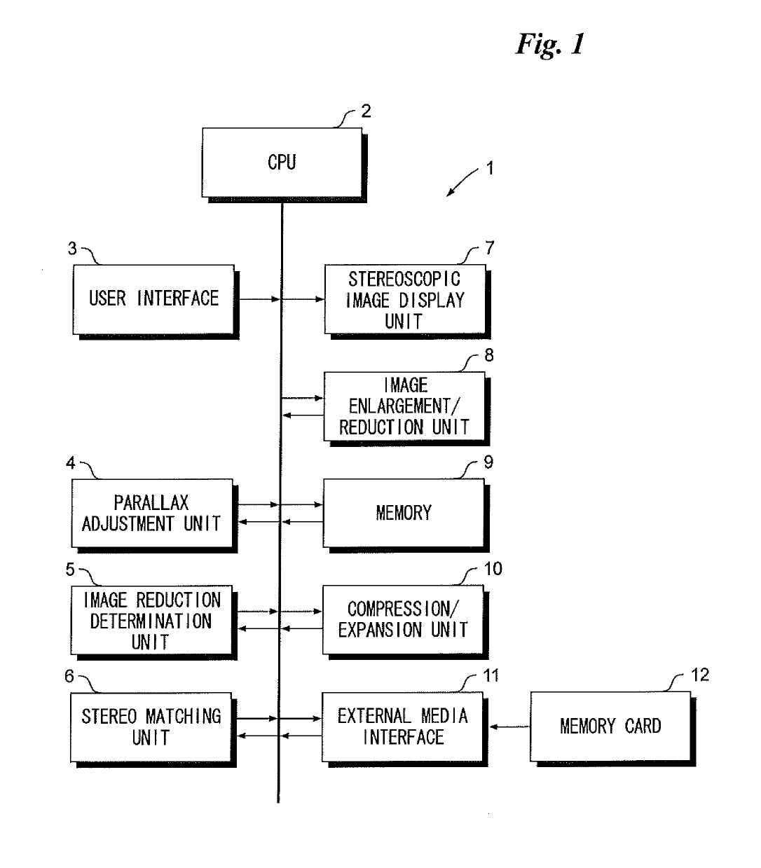

FIG. 1, which shows an embodiment of the present invention, is a block diagram illustrating the electrical configuration of an image viewer 1.

The image viewer 1 according to this embodiment can display a stereoscopic image and makes it possible to carry out a parallax adjustment so as to facilitate stereoscopic vision. Since it is difficult to achieve stereoscopic vision when parallax is too great, in this embodiment a parallax adjustment can be performed upon reducing the size of the stereoscopic image.

The overall operation of the image viewer 1 is controlled by a CPU 2.

The image viewer 1 includes a user interface 3 that has an adjusting dial for supplying the image viewer 1 with an amount of adjustment for the purpose of adjusting parallax, and an operating unit for applying commands; a parallax adjustment unit 4; an image reduction determination unit 5 for determining whether image reduction processing is necessary or not; and a stereo matching unit 6 for discriminating a pixel-by-pixel match between a left-viewpoint image and a right-viewpoint image in order to calculate the amount of parallax of a stereoscopic image.

The image viewer 1 further includes a stereoscopic image display unit 7 for displaying a stereoscopic image; an image enlargement/reduction unit 8 for performing enlargement and reduction of a stereoscopic image; a memory 9 for storing prescribed data; a compression/expansion unit 10 for performing compression and expansion of image data; and an external media interface 11 for accessing a memory card 12. Stereoscopic image data (image data representing a left-viewpoint image and image data representing a right-viewpoint image) representing a stereoscopic image has been stored on the memory card 12.

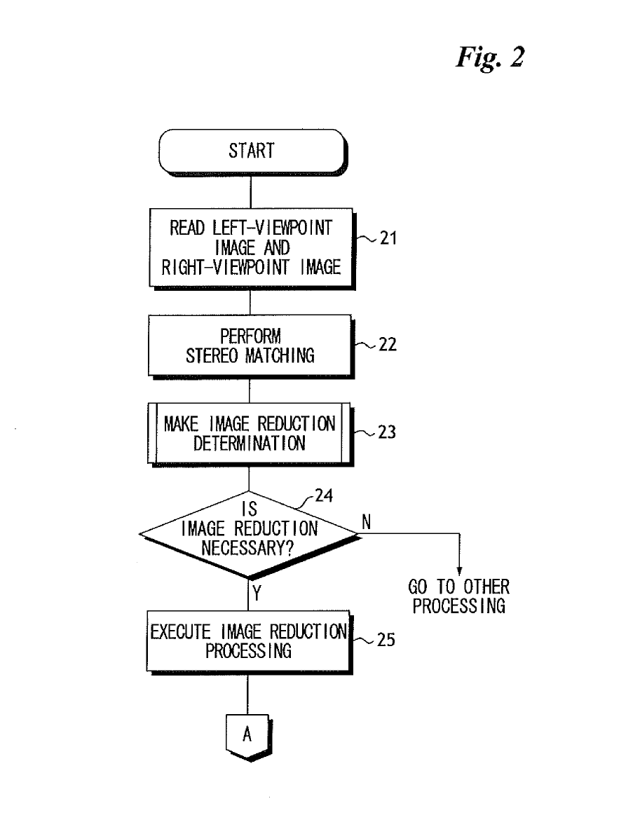

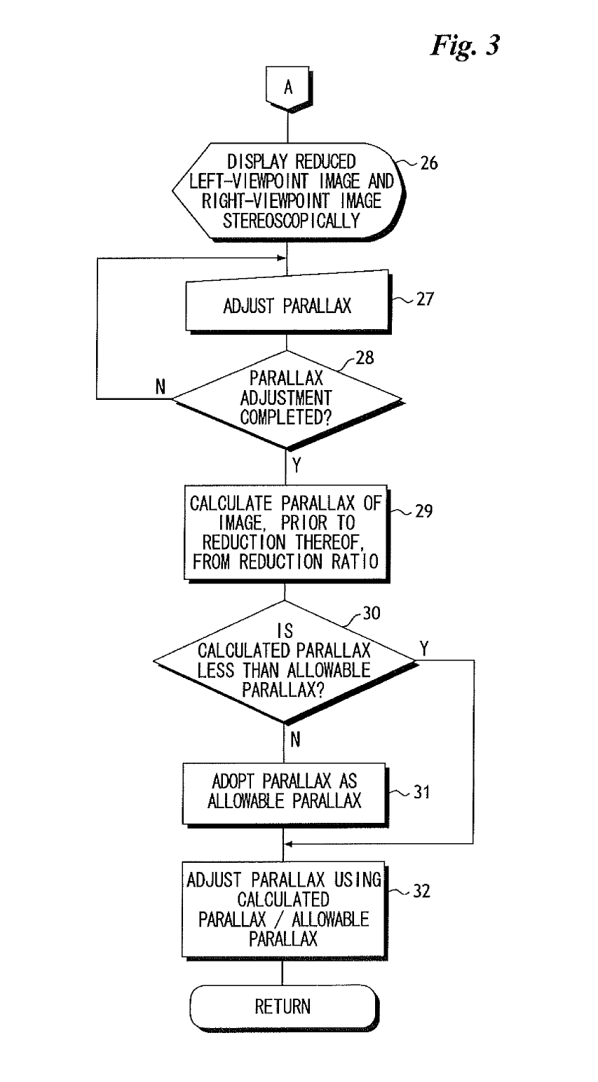

FIGS. 2 and 3 are flowcharts illustrating the processing procedure of the image viewer 1.

First, desired image data representing a left-viewpoint image and image data representing a right-viewpoint image is read from the memory card 12 (step 21 in FIG. 2).

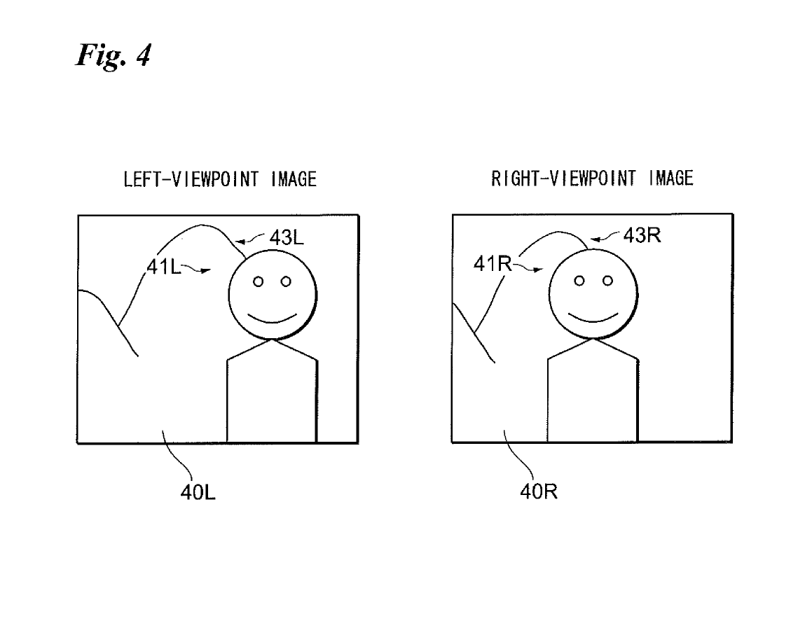

FIG. 4 is one example of a left-viewpoint image 40L and right-viewpoint image 40R.

With reference to the left side of FIG. 4, the left-viewpoint image 40L is an image obtained by imaging from the left viewpoint. The left-viewpoint image 40L contains a person image 41L and a background image 43L of a mountain. With reference to the right side of FIG. 4, the right-viewpoint image 40R is an image obtained by imaging from the right viewpoint.

The right-viewpoint image 40R contains a person image 41R and a background image 43R which correspond to the person image 41L and background image 43L of the mountain, respectively, contained in the left-viewpoint image 40L.

The left-viewpoint image 40L shown on the left side of FIG. 4 and the right-viewpoint image 40R shown on the right side of FIG. 4 have parallax because they have been captured from different viewpoints.

Stereo matching is performed between the left-viewpoint image 40L and right-viewpoint image 40R (step 22 in FIG. 2) and the amount of parallax is calculated, pixel by pixel, between the left-viewpoint image 40L (or the right-viewpoint image 40R) and the right-viewpoint image 40R (or the left-viewpoint image 40L) using the left-viewpoint image 40L (or the right-viewpoint image 40R) as a reference. Naturally, it may be arranged so that, in a case where the left-viewpoint image 40L (or right-viewpoint image 40R) has been partitioned into blocks having a prescribed size, the amount of parallax is calculated between the left-viewpoint image 40L (or the right-viewpoint image 40R) and the right-viewpoint image 40R (or the left-viewpoint image 40L) block by block and not pixel by pixel. A pixel can also be considered to be a block. In addition to utilizing block matching, matching can utilize the feature-point tracker of Kanade-Lucas-Tomasi, a SIFT (Scale Invariant Feature Transform) or the like.

Next, a parallax histogram between the left-viewpoint image 40L and the right-viewpoint image 40R is generated and an image reduction determination is made based upon the parallax histogram generated (step 23 in FIG. 2).

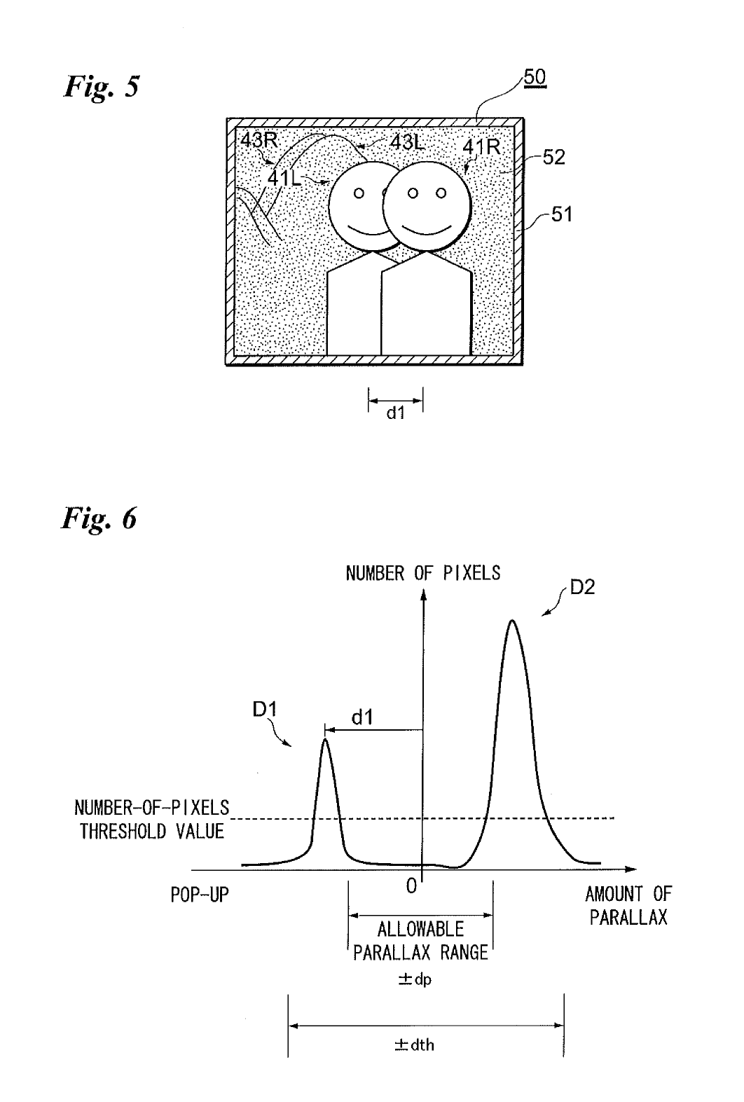

FIG. 5 is one example of a stereoscopic image 52.

The stereoscopic image 52 is obtained by displaying the left-viewpoint image 40L and the right-viewpoint image 40R, which have parallax between them, on a display screen 50. Since the size of the stereoscopic image 52 is smaller than the size of the display screen 50, a frame 51 (indicated by the hatching) appears surrounding the stereoscopic image 52. A person represented by the person images 41L and 41R is present in front of the mountain background represented by the background images 43L and 43R. In this embodiment, parallax is adjusted so as to make it easy to view the person. The parallax between the person images 41L and 41R is represented by d1. If the parallax between the person images 41L and 41R is too large, for example, stereoscopic vision will be difficult to achieve and, hence, so will the parallax adjustment. If the stereoscopic image formed from the left-viewpoint image 40L and right-viewpoint image 40R is considered to be difficult to view based upon the parallax histogram, image reduction processing is executed. Since the parallax between the left-viewpoint image 40L and right-viewpoint image 40R is reduced by executing image reduction processing, the stereoscopic image becomes easier to view and the parallax adjustment is facilitated as well. Image reduction processing is not executed if the stereoscopic image is easy to view. The details of image reduction processing will be described later.

FIG. 6 is one example of a parallax histogram of the stereoscopic image 52 shown in FIG. 5.

In FIG. 6, the horizontal axis indicates amount of parallax and the vertical axis indicates number of pixels. The “0” at the center of the horizontal axis representing amount of parallax is a cross point where the parallax is zero. The side to the left of the center “0” indicates amount of parallax at which the image pops up in 3D, and the side to the right of the center “0” represents amount of parallax indicative of depth in 3D.

A distribution D1 on the left side indicates the distribution of amount of parallax between the person images 41L and 41R, and a distribution D2 on the right side indicates the distribution of amount of parallax between the background images 43L and 43R.

In this embodiment, a parallax range ±dth that will contain many pixels from among all pixels Nall of the left-viewpoint image 40L or right-viewpoint image 40R is defined. Further, an allowable parallax range ±dp is defined. Since parallax d1 between the person images 41L and 41R (namely the peak parallax in the distribution of amount of parallax between the person images 41L and 41R) does not fall within the allowable parallax range ±dp, stereoscopic vision is difficult to achieve.

If stereoscopic vision is thus difficult to achieve, it is determined that reduction of the stereoscopic image is necessary. If reduction of the stereoscopic image is deemed to be necessary in the image reduction determination (“YES” at step 24 in FIG. 2), then processing for reducing the stereoscopic image is executed (step 25 in FIG. 2). If it is judged that reduction of the stereoscopic image is not necessary (“NO” at step 24 in FIG. 2), then a parallax adjustment and other processing are carried out using the stereoscopic image without reducing the size thereof. The reduced stereoscopic image is displayed on the display screen 50 (step 26 in FIG. 3).

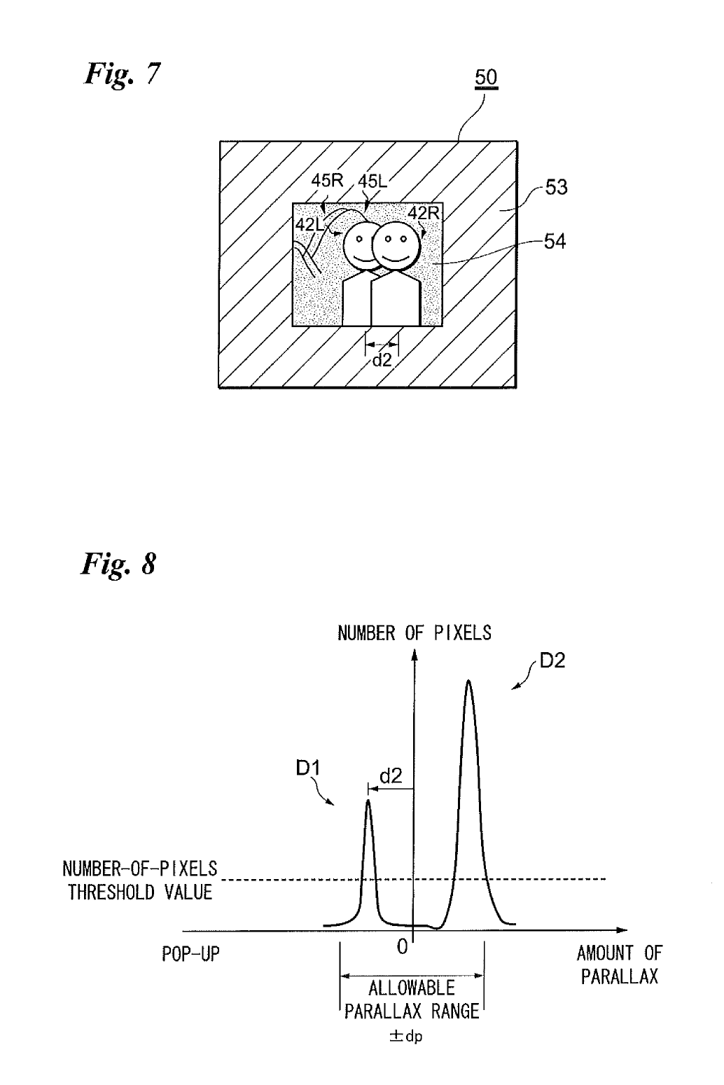

FIG. 7 is one example of a stereoscopic image 54 that has undergone reduction processing.

The reduced stereoscopic image 54 contains person images 42L and 42R, which correspond to the above-mentioned person images 41L and 41R that existed prior to the size reduction. Also contained are background images 45L and 45R, which correspond to the background images 43L and 43R prior to the size reduction. Since the stereoscopic image 54 has been reduced, the size of a frame 53 (indicated by the hatching) displayed surrounding the stereoscopic image 54 on the display screen 50 is larger than before. Furthermore, since the stereoscopic image 54 has been reduced in comparison with the stereoscopic image 52 shown in FIG. 5, parallax d2 between the person images 42L and 42R is small in comparison with the parallax between the person images 41L and 41R contained in the stereoscopic image 52 that existed prior to reduction.

FIG. 8 is one example of a parallax histogram after image reduction.

In FIG. 8, the distribution D1 on the left side is the parallax distribution between the person images 42L and 42R, and the distribution D2 on the right side is the parallax distribution between the background images 45L and 45R.

Owing to execution of image reduction processing, the parallax distribution D1 between the person images 42L and 42R and the parallax distribution D2 between the background images 45L and 45R are closer together. The amount of parallax of almost all pixels falls within the allowable parallax range ±dp. Accordingly, the parallax adjustment is easier to perform using the reduced stereoscopic image 54, as mentioned above. The parallax d2 between the person images 42L and 42R also falls within the allowable parallax range ±dp. This is a state in which stereoscopic vision is easy to achieve.

Thus, since the parallax between the person images 42L and 42R (parallax is not necessarily limited to the parallax between the person images 42L and 42R) of the stereoscopic image 54 obtained by reducing the size of the stereoscopic image 52 becomes smaller, the parallax adjustment is facilitated.

A parallax adjustment (first parallax adjustment) is performed with regard to the person images 42L and 42R contained in the reduced stereoscopic image (left-viewpoint image and right-viewpoint image) 54 (step 27 in FIG. 3), and the parallax adjustment is completed (“YES” at step 28 in FIG. 3).

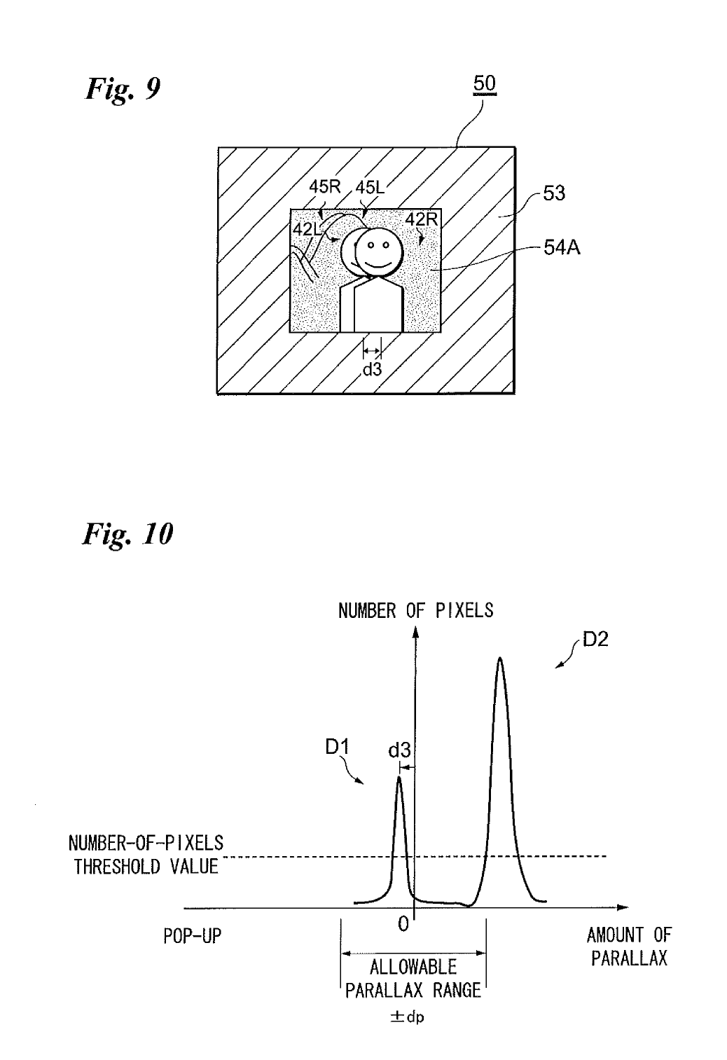

FIG. 9 is one example of a reduced image 54A that has undergone a parallax adjustment.

Owing to implementation of the parallax adjustment, the parallax between the person images 42L and 42R has changed from d2 to d3 (d3<d2).

FIG. 10 is a parallax histogram of the reduced image 54A that has undergone the parallax adjustment shown in FIG. 9.

Owing to implementation of the parallax adjustment with regard to the person images 42L and 42R, the parallax between them has become d3, as mentioned above. The parallax has been adjusted so as to facilitate stereoscopic viewing by the user.

If the parallax d3 that has been applied with regard to the reduced stereoscopic image 54A is enlarged in accordance with an enlargement ratio in a case where the stereoscopic image 54 is enlarged to the size of the stereoscopic image 52 that existed prior to reduction and is then applied to the left-viewpoint image 40L that existed prior to reduction (FIG. 4) and to the right-viewpoint image 40R that existed prior to reduction (FIG. 4), then it may happen that the allowable amount of parallax will be exceeded. (The allowable amount of parallax refers to an amount of parallax which affords a parallax-amount criterion that makes appropriate stereoscopic vision possible; it is dependent upon the size and stereoscopic display scheme of the display device). Therefore, in this embodiment, an amount of parallax, which conforms to an enlargement ratio in a case where the reduced stereoscopic image 54A has been enlarged to the size of the stereoscopic image 52 that existed prior to reduction, is calculated using a reduction ratio (step 29 in FIG. 3). If the calculated amount of parallax is not less than the allowable amount of parallax (“NO” at step 30 in FIG. 3), then, in order to facilitate stereoscopic vision, the left-viewpoint image 40L and the right-viewpoint image 40R are subjected to a parallax adjustment (second parallax adjustment) in such a manner that the amount of parallax will become the allowable amount of parallax (step 32 in FIG. 3). If the calculated amount of parallax is less than the allowable amount of parallax (“YES” at step 30 in FIG. 3), then the left-viewpoint image 40L and the right-viewpoint image 40R are subjected to a parallax adjustment using the calculated amount of parallax (second parallax adjustment) (step 32 in FIG. 3).

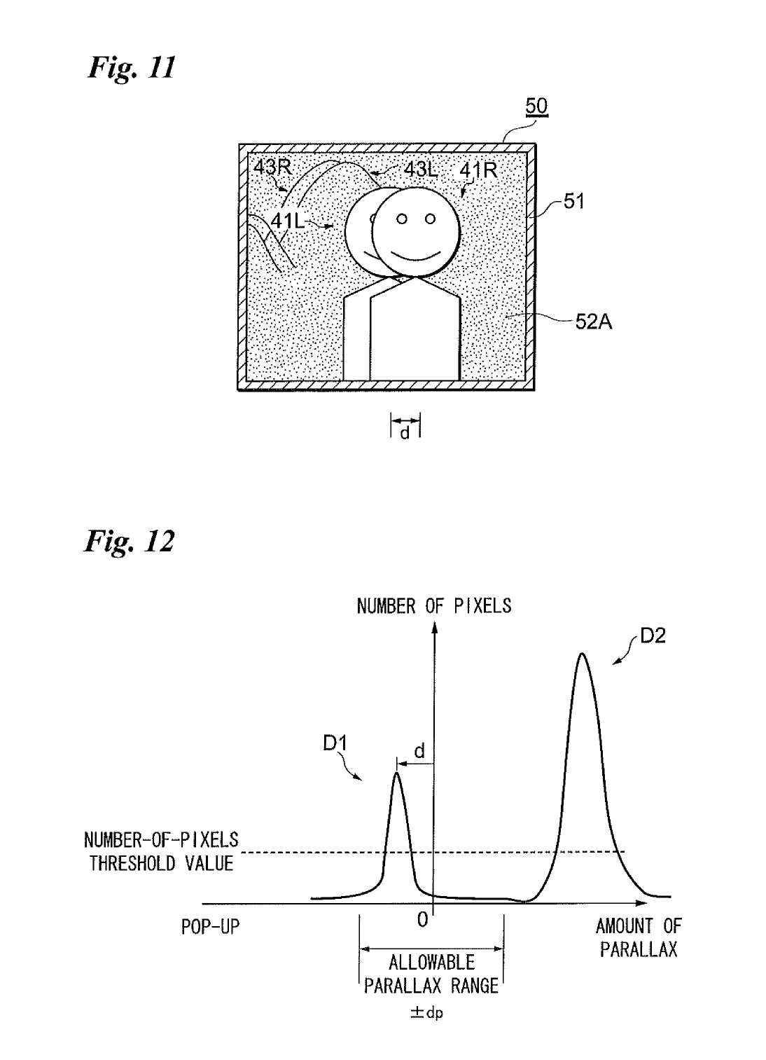

FIG. 11 is one example of a stereoscopic image 52A that has been subjected to a parallax adjustment using parallax calculated based upon parallax obtained by parallax adjustment of a reduced image in the manner described above. The stereoscopic image 52A is one obtained not by enlarging the stereoscopic image 54A but by subjecting the left-viewpoint image 40L and the right-viewpoint image 40R to a parallax adjustment in such a manner that the stereoscopic image takes on the parallax calculated in the manner described above.

The stereoscopic image 52A includes the above-mentioned person images 41L and 41R. The parallax d between the person images 41L and 41R has been calculated based upon the parallax d3 in the reduced image 54A. It goes without saying that if the calculated parallax d exceeds the allowable amount of parallax, the parallax taken on by the stereoscopic image will be the allowable amount of parallax, as described above.

The parallax d1 between the person images 41L and 41R in the stereoscopic image 52 is d1, as illustrated in FIG. 5, and the parallax between the person images 42L and 42R in the stereoscopic image 54 obtained by reduction as shown in FIG. 7 is d2. Letting R represent the reduction ratio, we have parallax d2=d1×R. Assume that d3=d2+c1 (where c1 is the amount of parallax adjustment) holds as a result of performing a parallax adjustment with regard to the reduced image 54. The parallax d conforming to the reduction ratio is calculated in order to apply the parallax d3 to the left-viewpoint image 40L and right-viewpoint image 40R that existed prior to reduction. The parallax d applied to the person images 41L and 41R of the left-viewpoint image 40L and right-viewpoint image 40R that existed prior to reduction is d=d3/R (d1×R+c1)/R=d1+(c1/R). If this parallax d exceeds the allowable amount of parallax, it is adopted as the allowable amount of parallax. The parallax d need not be limited to the allowable amount of parallax as a matter of course.

FIG. 12 is one example of a parallax histogram of the stereoscopic image 52A that has been parallax-adjusted by applying the calculated parallax d.

Since the amount of parallax adjustment of the stereoscopic image 52A shown in FIG. 11 is greater than the amount of parallax adjustment of the reduced stereoscopic image 54A shown in FIG. 9, the gap widens between the parallax distribution D1 of the person images 41L and 41R and the parallax distribution D2 of the background images 43L and 43R.

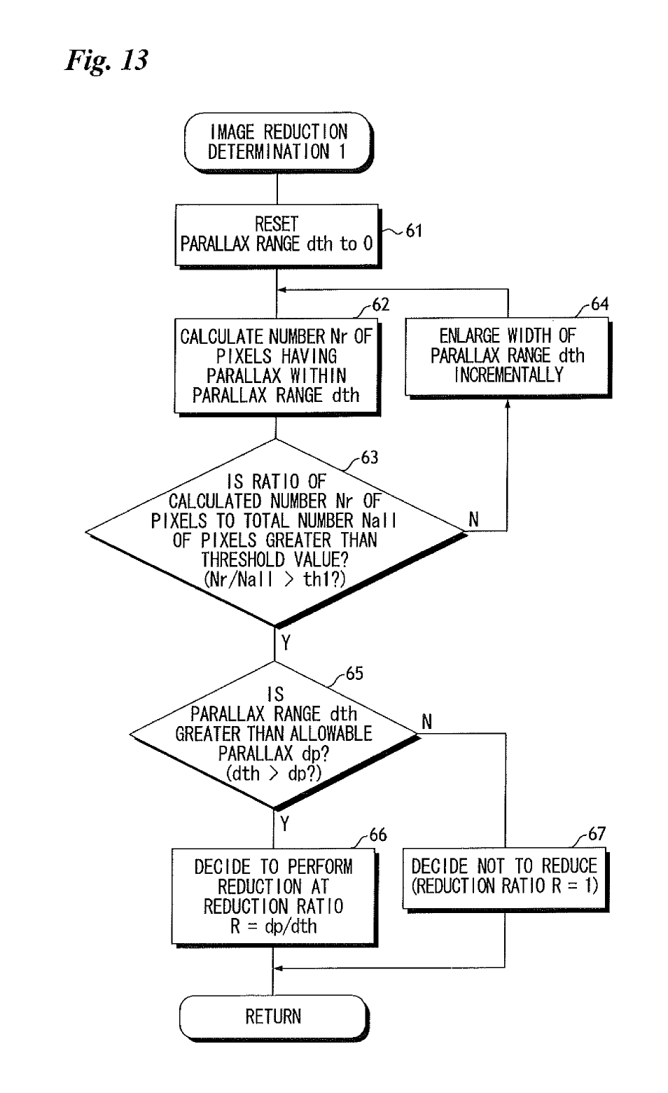

FIG. 13 is a flowchart illustrating a processing procedure for determining image reduction (the processing procedure of step 23 in FIG. 2).

As illustrated in FIG. 9, a parallax histogram representing parallax between the pixels of the left-viewpoint image 40L (see FIG. 4) and the pixels of the right-viewpoint image 40R (see FIG. 4) is generated.

First, the parallax range ±dth is reset to zero (step 61 in FIG. 13).

Next, the number Nr of pixels having a parallax that falls within the parallax range ±dth is calculated (step 62 in FIG. 13). Until the ratio of the calculated number Nr of pixels to the number Nall of all pixels becomes greater than a prescribed threshold value th1 (0.9, for example) (step 63), the width of the parallax range ±dth is enlarged incrementally (step 64 in FIG. 13). When the ratio of the calculated number Nr of pixels to the number Nall of all pixels becomes greater than the prescribed threshold value th1 (“YES” at step 63 in FIG. 13), a parallax range ±dth containing many pixels from among all pixels Nall is decided upon.

If the parallax range ±dth thus decided is equal to or less than the allowable parallax ±dp (“NO” at step 65 in FIG. 13), then such a stereoscopic image will readily lend itself to stereoscopic vision and it is therefore decided that reduction processing is not to be executed (reduction ratio=1) (step 67 in FIG. 13).

If the parallax range ±dth is greater than the allowable parallax ±dp (“YES” at step 65 in FIG. 13), then it is decided to perform reduction at the reduction ratio R=dp/dth (step 66 in FIG. 13). By virtue of such an image reduction, the parallax distribution can be made to fall within the allowable parallax range ±dp.

It may be arranged so that calculation of the parallax range ±dth described above as a characteristic of stereoscopic vision is performed utilizing only the parallax of pixels having a strong edge obtained by edge detection (pixels of vertical lines, for example), or it may be arranged so as to exclude the parallax of a subject having low contrast.

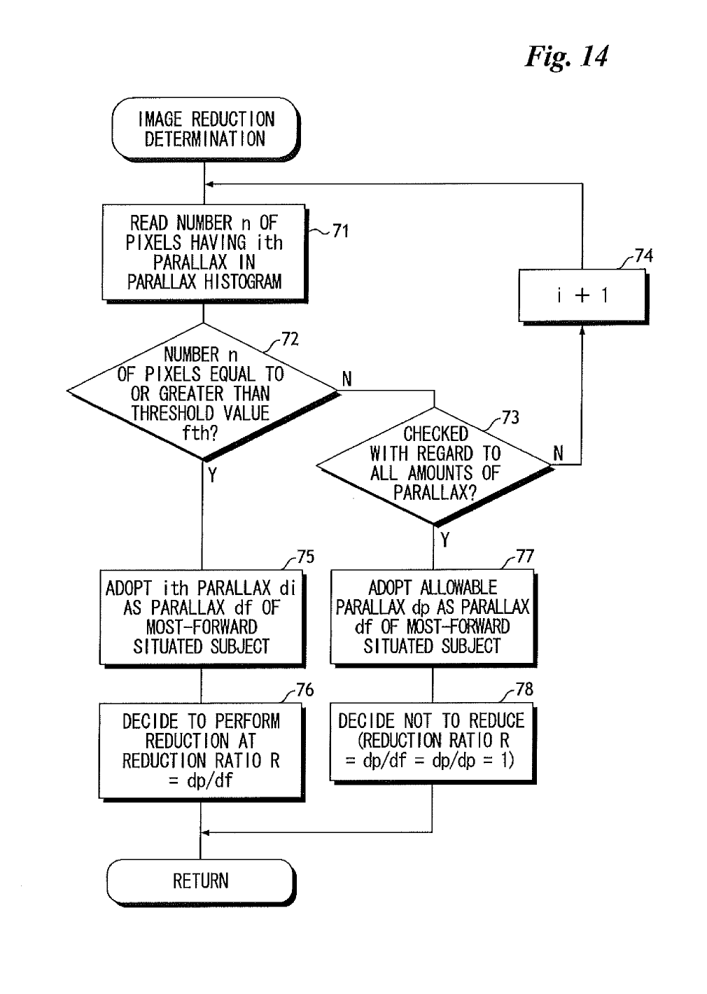

FIG. 14 is a flowchart illustrating another example of a processing procedure for determining image reduction (the processing procedure of step 23 in FIG. 2).

In this embodiment, the setting of the image reduction ratio R is carried out in accordance with the amount of parallax of a forward-situated subject, taking into consideration the fact that excessive stereographic pop-up parallax in a stereoscopic image hinders comfortable stereoscopic vision. A parallax histogram is generated in a manner similar to that described above.

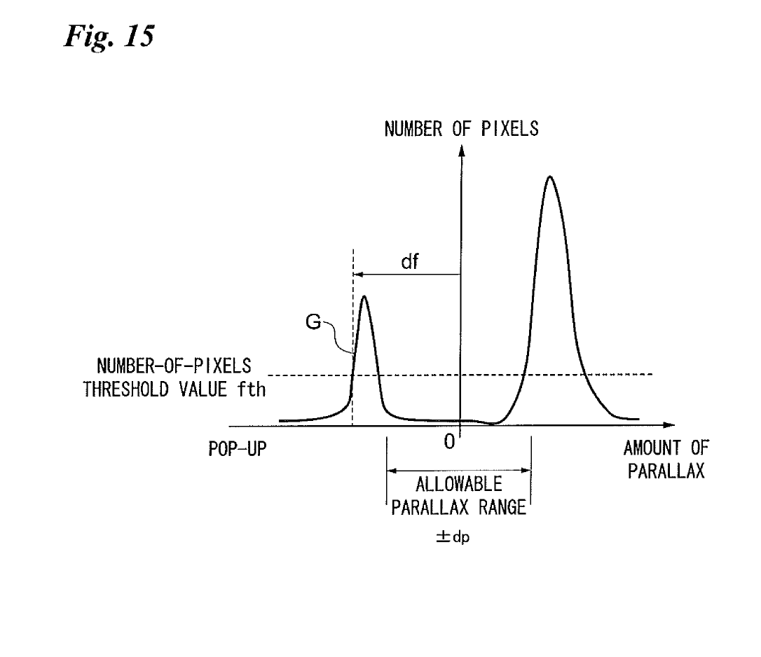

FIG. 15 is one example of a parallax histogram G.

In a manner similar to that of the above-described histograms, the horizontal axis indicates amount of parallax and the vertical axis indicates number of pixels. Since the parallax histogram indicates about how many pixels possess an amount of parallax, the histogram represents the number of pixels versus the amount of parallax.

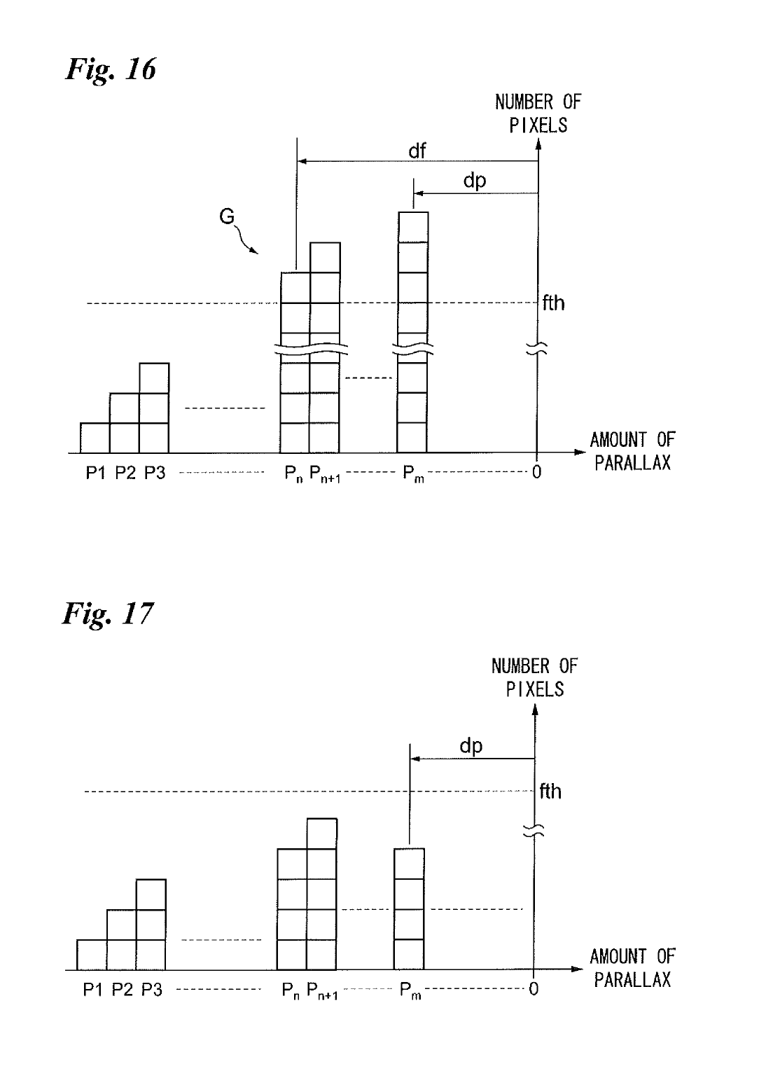

FIG. 16 illustrates an enlargement of a portion of the parallax histogram G.

As mentioned above, the parallax histogram G represents the number of pixels versus the amount of parallax. For example, the number of pixels having an amount P1 of parallax is one, and the number of pixels of an amount P2 of parallax is two. Thus, the number of pixels corresponding to the amount of parallax can be ascertained from the parallax histogram G.

First, a number n of pixels having an ith amount of parallax in the parallax histogram is read (at the beginning the amount of parallax will have been reset to the amount of parallax of the pixel having the largest amount of stereographic pop-up, namely the most forward-situated pixel) (step 71 in FIG. 14). If the obtained number n of pixels is not equal to or greater than a threshold value fth (“NO” at step 72 in FIG. 14), there will be little effect. Therefore, if all amounts of parallax have not been checked (“NO” at step 73 in FIG. 14), i is incremented (step 74 in FIG. 14) and a number n of pixels having the next amount of parallax on the depth side is read (step 71 in FIG. 14).

When the number of pixels having an amount Pn of parallax becomes equal to or greater than the threshold value fth (“YES” at step 72 in FIG. 14), as shown in FIG. 16, this ith amount di of parallax is adopted as an amount df of parallax of the subject that is situated most forward (step 75 in FIG. 14). It is decided to perform reduction at a reduction ratio R=dp/df in such a manner that the amount df of parallax will fall within the allowable parallax amount dp (step 76 in FIG. 14).

FIG. 17 illustrates an enlargement of a parallax histogram in a case where pixels that exceed the threshold value fth do not exist.

If a portion having a number of pixels that exceeds the threshold value fth does not exist even if amounts of parallax of all pixels have been checked (“NO” at step 72, “YES” at step 73 in FIG. 14), then the allowable parallax dp is adopted as the amount df of parallax of the most forward-situated subject (step 77 in FIG. 14) and a decision not to perform reduction is made (step 78 in FIG. 14). Reduction ratio R=dp/df=dp/dp=1 will hold.

In the foregoing embodiment, control is carried out in accordance with the amount of parallax of a subject that is forward situated. However, in a case where emphasis is placed on a subject farther in the depth direction, it will suffice to execute processing similar to the above-described processing in order from the amount of parallax of a subject farther in the depth direction.

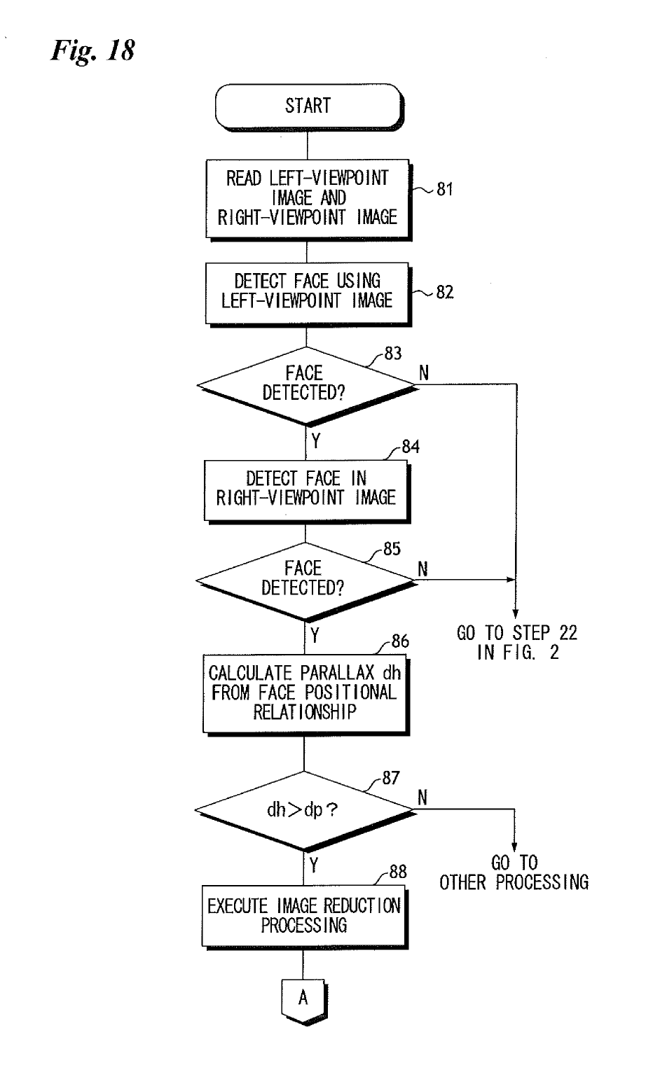

FIGS. 18 to 21 illustrate another embodiment.

This embodiment detects a specific subject such as a face image (although the subject is not necessarily limited to a face image) and reduces the size of a stereoscopic image if the parallax of the detected specific subject is greater than the allowable parallax. Further, when processing for reducing a stereoscopic image is executed, processing is also executed for lowering the contrast of at least one image of a left-viewpoint image and right-viewpoint image that form the stereoscopic image. The contrast is restored to the original in accordance with a parallax adjustment. Naturally, processing for lowering contrast need not necessarily be executed.

Processing for lowering contrast may be executed without executing processing for reducing the size of the stereoscopic image.

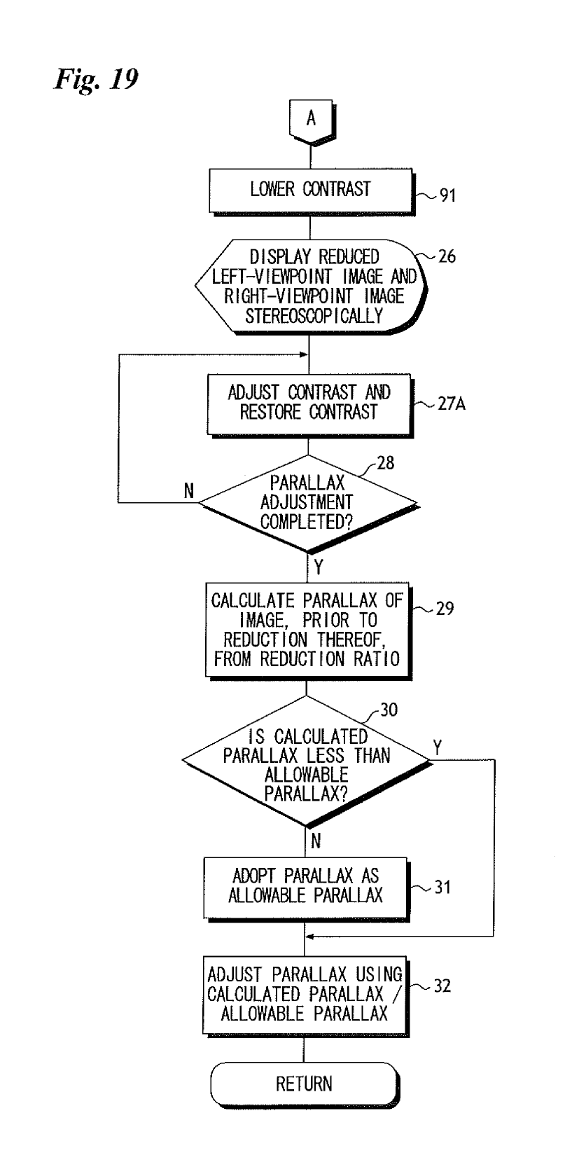

FIGS. 18 and 19 are flowcharts illustrating the processing procedure of the image viewer 1. Processing steps in these figures identical with those shown in FIG. 2 or FIG. 3 are designated by like step numbers and a description thereof is omitted.

The left-viewpoint image 40L and right-viewpoint image 40R are read from the memory card 12 (step 81 in FIG. 18), in a manner similar to that described above, and processing for detecting a face in the left-viewpoint image 40L is executed (step 82 in FIG. 18). If a face is detected from the left-viewpoint image 40L (“YES” at step 83 in FIG. 18), processing for detecting a face identical with the face detected in the left-viewpoint image 40L is executed with regard to the right-viewpoint image 40R (step 84 in FIG. 18). For example, a face image detected in the left-viewpoint image 40L is adopted as a template image and an image identical with the template image is detected from the right-viewpoint image 40R. If a face image identical with the face image detected from the left-viewpoint image 40L is detected from the right-viewpoint image 40R (“YES” at step 85 in FIG. 18), the amount dh of parallax of the face is calculated from the positional relationship of the face (step 86 in FIG. 18). If the calculated amount dh of parallax of the face is greater than the allowable parallax amount dp (“YES” at step 87), then image reduction is applied to the stereoscopic image in the manner set forth above (step 88 in FIG. 18). If the calculated amount dh of parallax of the face is equal to or less than the allowable parallax amount dp (“NO” at step 87), image reduction processing is not executed and other processing, such as execution of a parallax adjustment, is applied to the stereoscopic image that has not been reduced in size.

Next, contrast is reduced with regard to at least one image of the left-viewpoint image and right-viewpoint image forming the stereoscopic image (step 91 in FIG. 19). It goes without saying that if the stereoscopic image has been reduced, the contrast of the reduced image is lowered. If the contrast has been lowered, it is preferred that the user be so notified. For example, a message reading “THE DISPLAY MODE HAS BEEN CHANGED BECAUSE THE STEREOSCOPIC EFFECT OF THE IMAGE IS INAPPROPRIATE” is displayed.

When a parallax adjustment is subsequently carried out using the reduced stereoscopic image, the contrast is restored to the original in accordance with this parallax adjustment (step 27A in FIG. 19). It becomes possible to indicate the degree of parallax adjustment by the change in contrast.

The contrast adjustment may be performed by adjusting the overall image using a uniform value, or only an area that exceeds the allowable parallax may have its contrast lowered.

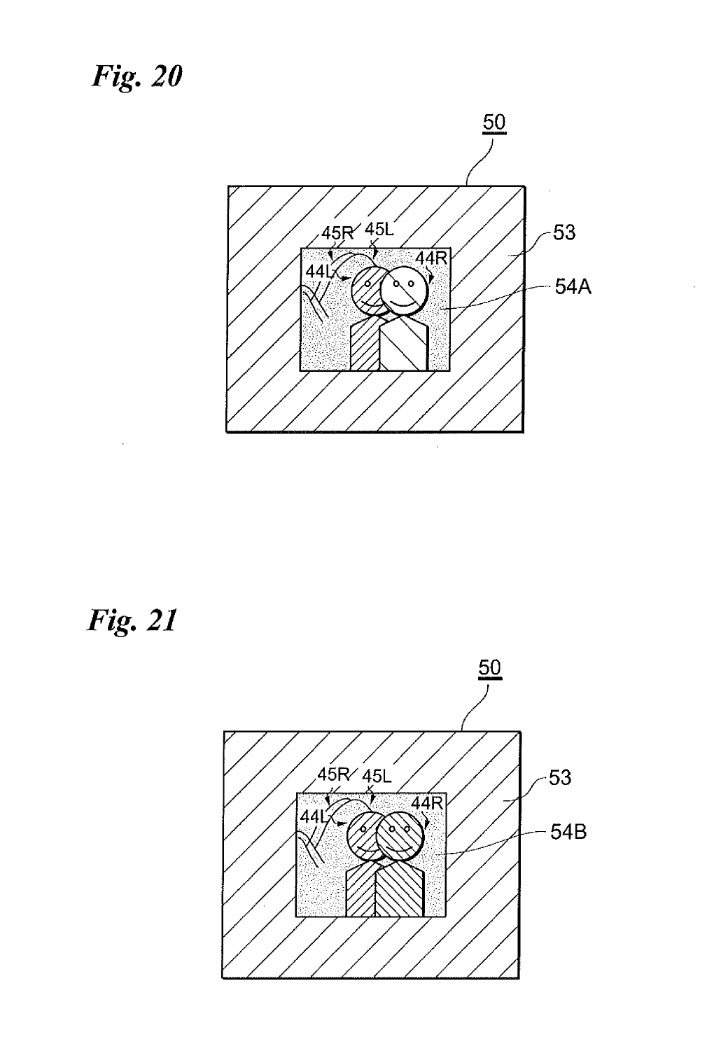

FIGS. 20 and 21 are examples of the stereoscopic image 52A.

With reference to FIG. 20, stereoscopic image 54A contains a person image 44L obtained from a left-viewpoint image and a person image 44R obtained from a right-viewpoint image. The contrasts of the respective person images 44R and 44L are indicated by hatching. The contrast of the right-viewpoint image has been lowered in the manner described above.

When a parallax adjustment is carried out, the contrast changes and, as illustrated in FIG. 21, the original contrast is restored in accordance with completion of the parallax adjustment.

As set forth above, it may be arranged to detect the amount of parallax that corresponds to a forward-situated subject and to lower contrast in the manner described above in a case where the absolute value of this amount of parallax exceeds an allowable parallax.

1. A parallax adjustment apparatus comprising:
a parallax calculation device for calculating, pixel by pixel, amount of parallax between a first image, which serves as a reference, and a second image, the first and second images having different viewpoints;
a reduction ratio decision device for deciding a reduction ratio of the first and second images based upon the amount of parallax calculated by said parallax calculation device and a prescribed allowable amount of parallax;
a reduction device for reducing the first and second images at the reduction ratio decided by said reduction ratio decision device;
a stereoscopic image display control device for controlling a display unit in such a manner that a stereoscopic image, which comprises the first and second images reduced by said reduction device, is displayed on a display screen;
a first parallax adjustment device for accepting a parallax adjustment command and adjusting the amount of parallax between the first and second images, which have been reduced by said reduction device, in accordance with an amount of parallax commanded; and
a second parallax adjustment device for making the amount of parallax, which existed prior to reduction by said reduction device, between the first and second images of different viewpoints, an amount of parallax that will exist when the first and second images, which have had their amount of parallax adjusted by said parallax adjustment device and have been reduced, are enlarged so as to take on the size that existed prior to the reduction by said reduction device.

2. A parallax adjustment apparatus according to claim 1, wherein said second parallax adjustment device adjusts the amount of parallax in such a manner that the amount of parallax between the first and second images will fall below the allowable amount of parallax.

3. A parallax adjustment apparatus according to claim 1, wherein said reduction ratio decision device decides the reduction ratio in such a manner that the amount of parallax of pixels equal to or greater than a prescribed number of pixels among pixels of the first image will be the allowable amount of parallax.

4. A parallax adjustment apparatus according to claim 1, wherein in a case where the first image has been partitioned into blocks of a prescribed size, said parallax calculation device calculates, block by block, the amount of parallax between the first image, which serves as a reference, and the second image; and
said reduction ratio decision device performs reduction in such a manner that a maximum amount of parallax among absolute values of amounts of parallax of blocks, which have an amount of parallax equal to or greater than the allowable amount of parallax and the number of which is equal to or greater than a threshold value, will be the allowable amount of parallax.

5. A parallax adjustment apparatus according to claim 1, further comprising:
a first contrast adjustment device for lowering contrast of the first and second images that have been reduced by said reduction device; and
a second contrast adjustment device for restoring the contrast of the first and second images, the amount of parallax of which has been adjusted by said second parallax adjustment device, to the contrast that existed prior to the adjustment of contrast by said first contrast adjustment device.

6. A parallax adjustment apparatus according to claim 1, wherein said parallax calculation device calculates amount of parallax of a subject image which, of the first and second images, is the image situated most forward.

7. A parallax adjustment apparatus according to claim 1, wherein said parallax calculation device calculates, from the first and second images, an amount of parallax of a predetermined prescribed subject; and
said reduction ratio decision device calculates the amount of parallax of the prescribed subject calculated by said parallax calculation device.

8. A method of controlling operation of a parallax adjustment apparatus, comprising:
a parallax calculation device calculating, pixel by pixel, amount of parallax between a first image, which serves as a reference, and a second image, the first and second images having different viewpoints;
a reduction ratio decision device deciding a reduction ratio of the first and second images based upon the amount of parallax calculated by said parallax calculation device and a prescribed allowable amount of parallax;
a reduction device reducing the first and second images at the reduction ratio decided by said reduction ratio decision device;
a stereoscopic image display control device controlling a display unit in such a manner that a stereoscopic image, which comprises the first and second images reduced by said reduction device, is displayed on a display screen;
a first parallax adjustment device accepting a parallax adjustment command and adjusting the amount of parallax between the first and second images, which have been reduced by said reduction device, in accordance with an amount of parallax commanded;
a second parallax adjustment device making the amount of parallax, which existed prior to reduction by said reduction device, between the first and second images of different viewpoints, an amount of parallax that will exist when the first and second images, which have had their amount of parallax adjusted by said parallax adjustment device and have been reduced, are enlarged so as to take on the size that existed prior to the reduction by said reduction device.
